(19) United States
(12) Patent Application Publication
(10) Pub. No.: US 2022/0235597 A1
(43) Pub. Date: Jul. 28, 2022

(54) TENSIONING DEVICE FOR A DRIVE TRAIN

(71) Applicant: Automatic Technology (Australia) Pty Ltd, Keysborough, Victoria (AU)

(72) Inventors: Raymond Hawkins, Keysborough, Victoria (AU); George Matthews, Springvale, Victoria (AU)

(21) Appl. No.: 17/612,843

(22) PCT Filed: Jun. 5, 2020
(86) PCT No.: PCT/AU2020/050571

§ 371 Date: Nov. 19, 2021

(30) Foreign Application Priority Data
Jun. 5, 2019 (AU) 2019901950

(51) Int. Cl. E05F 15/686

(52) U.S. Cl. CPC E05F 15/686; E05Y 2201/474; E05Y 2201/652; E05Y 2900/132; E05Y 2201/672; E05Y 2201/64; E05Y 2900/106; E05Y 2201/668

(57) ABSTRACT

A tensioning device for a door operating system includes a pulley carriage on which a pulley of the door operating system is mounted for rotation, the pulley carriage being movable relative to a track of the door operating system. The tensioning device further includes an adjuster configured to move the pulley carriage relative to the track and thereby alter a level of tension in a longitudinal drive component of the door operating system, the adjuster of the tensioning device being accessible from an end of the tensioning device facing a track operator end of the door operating system. The tensioning device also includes a resilient member operatively engaged with the adjuster, the resilient member configured to provide damping of forces experienced by the longitudinal drive component.

### FIELD OF THE INVENTION

The present invention generally relates to a tensioning device used in the drive train of a door opening system.

### BACKGROUND OF THE INVENTION

The use of tensioning devices with a drive train are generally well known. One area of application for a tensioning device is part of a drive train for a door operating system, such as for a garage sectional door. The door is generally moved between open and closed positions by a door operator, which drives a belt or chain that is attached to a trolley that runs forward and backward along a track or rail mounted to the garage ceiling, with the trolley attached to the door via a closure arm. Over time, continued movement of the trolley back and forth along the track during door opening and closing operations can lead to a slackening in the belt or chain through wear, leading to excessive movement of components of the drive train, thereby creating noise and possibly causing damage.

When the above issue is encountered, the belt or chain is generally tensioned by adjusting a belt or chain tensioner provided as an adjustment bolt until the tension in the belt or chain is sufficient to overcome the above issues. However, adjustment of the tensioning device is often inconvenient due to the conventional positioning of the tensioning device proximate the wall above the door, with the adjustment bolt usually positioned very close to the wall, outboard from the idler pulley, and thus difficult to access.

It is known for such tensioning devices to include a spring, the coils of which surround the shank of the adjustment bolt, with the spring serving as a shock absorber when the belt or chain experiences sudden or excessive loading that can sometimes occur during initiating or halting opening or closing of the door. In these applications, the spring is generally pre-loaded when the level of tension in the belt or chain is being set. However, it is important that the spring is still able to compress and thus provide resilient resistance during operation in order to provide shock absorption.

It is desirable to provide a tensioning device that addresses at least in part one or more of the above problems with conventional tensioners, or provides a useful alternative to the known tensioners.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a tensioning device for a door operating system, the door operating system including a track, a longitudinal drive component to be tensioned, the longitudinal drive component running along the track between a track door end and a track operator end, a powered operator arranged to drive the longitudinal drive component and a pulley configured to operatively engage the longitudinal drive component adjacent the track door end, the tensioning device including: a pulley carriage on which the pulley is mounted for rotation, the pulley carriage being movable relative to the track; an adjuster configured to move the pulley carriage relative to the track and thereby alter a level of tension in the longitudinal drive component, the adjuster of the tensioning device being accessible from an end of the tensioning device facing said track operator end; and a resilient member operatively engaged with the adjuster, the resilient member configured to provide damping of forces experienced by the longitudinal drive component.

Advantageously, the longitudinal drive component (belt, chain, or other suitable transmissive component), can be tensioned by a user in a simpler manner than is conventional because the adjustment means of the tensioning device is provided on the end facing the track operator end, rather than at an end facing the track door end, where a user generally has a very limited amount of space to access the adjuster and effect adjustment.

Preferably, the adjuster includes a drive part for manipulation by a user to effect the adjustment, the adjuster drive part being disposed at a position on the side of the pulley carriage towards the track operator end, in order to render it accessible from an end of the tensioning device facing said track operator end. In a preferred form the adjuster drive part is a head of an adjustment bolt or screw, rotation of which (eg. by way of a suitable tool) effects adjustment of the level of tension in the longitudinal drive component.

The resilient member is preferably a spring, particularly a compression spring. However, the resilient means may be of any other suitable form capable of absorbing and releasing load transferred thereto. For example, in certain embodiments the resilient means may be a tension spring or torsion spring, or may be formed of a body of a polymer or rubberised material, configured to provide the required resilience.

The pulley carriage preferably includes a surface on which the load from the adjuster bears in order to move the carriage. The carriage may include lateral portions that engage with the track to facilitate axial movement of the carriage along the track, while preclude substantial movement of the carriage in any other direction. These lateral portions may be provided as wings or outriggers to minimise material and therefore weight, sized and shaped to suit the dimensions of the track.

The adjuster is preferably an adjustment bolt engaging with a threaded element mounted in a fixed position relative to the track, rotation of the adjustment bolt in a tightening direction bearing on the resilient member, which bears on the carriage. The adjustment bolt may bear on a bearing element such as a plate, which in turn bears on the resilient member.

In a preferred embodiment, the belt tensioning device further comprises a retention structure disposed between the carriage and the adjuster, the retention structure configured to confine the resilient member. The retention structure can be of any suitable form that acts to confine the resilient member to its operating position between the adjuster and the carriage. For example, the retention structure may be a housing in which the resilient member is contained. In another example, the retention structure may be a cage formed of multiple bars that extend around the resilient member in order to confine it in its operating position. In another form, the retention structure need not be external of the resilient member, but may pass wholly or partially within the resilient member (such as within the coils of a compression spring). The retention structure may be a separate part disposed between the carriage and the adjuster, and may be mountable to the carriage so that it moves therewith. Alternatively, the retention structure may be formed as part of the carriage and/or the adjuster.

As will be understood, the retention structure prevents the dislodgement or disengagement of the resilient member from its operating position, thus ensuring optimum operation of the device and minimising safety risks which might otherwise arise.

In an embodiment, the retention structure is configured to afford a visual indication of the loading of the resilient member, thus providing to a user an indication of the level of tension in the belt. The user is therefore able to monitor the preload of the resilient member at installation or on any subsequent visual inspection, for example as part of a regular maintenance check, and adjust it to always ensure an optimum level of shock absorption. As will be understood, an unsuitably low preload will generally indicate insufficient belt tension, while an unsuitably high preload will generally indicate that the belt is overloaded, and the resilient member not able to afford shock absorption.

The adjustment bearing element (such as a plate on which the adjuster bears) may be disposed within the retention structure. Visual inspection of the position of the adjustment bearing element within the retention structure can thus provide an indication of loading in the resilient member.

The indication of loading in the resilient member, which is afforded by a visual inspection of the retention structure, can be provided in many different ways. For example, the retention structure may include one or more openings that allow a user to view the resilient member or a part operatively engaged with the resilient member (such as said adjustment bearing element). In another embodiment, the retention structure may be wholly or partially transparent, allowing a user to visually inspect the loading in the resilient member.

In a further embodiment, the device may include an indicator element in operative engagement with the resilient member, the indicator element extending from the retention structure, with movement of the indicator element providing to a user a measure of the loading of the resilient member. In this way, the resilient member need not be visible. For example, the indicator element may comprise a pointer moving relative to a graduated scale on the retention structure. Alternatively, the visual indication may be provided electronically, such as via an encoder in operative engagement with the resilient member.

The tensioning device may include a chassis, wherein one or more component parts of the tensioning device are provided on the chassis, the chassis being configured to be mounted to the track. The chassis may be arranged for attachment to the wall defining the opening for which the door provides closure, e.g. by way of a mounting bracket.

In a second aspect, the present invention provides a door operating system including the tensioning device of the first aspect.

In an embodiment, the door operating system includes a motor powered operator configured to drive said longitudinal drive component.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 provides a perspective view of a door operating system;

FIG. 2 provides a bottom perspective view of a tensioning device in accordance with an embodiment of the present invention;

FIG. 3 provides a partly exploded bottom perspective view of the tensioning device of FIG. 2, depicting the various components; and

FIG. 4 provides a bottom view of another embodiment of the tensioning device installed to a track for mounting in a door operating system.

### DETAILED DESCRIPTION OF THE EMBODIMENTS

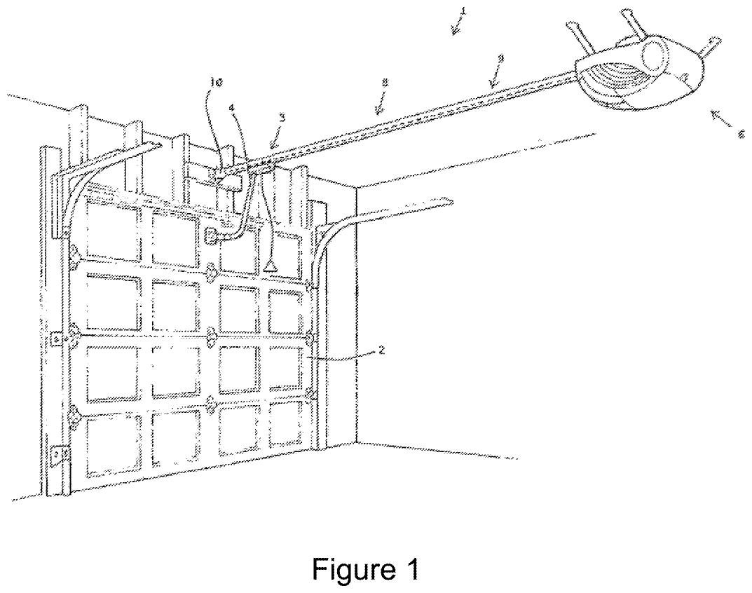

FIG. 1 illustrates a door operating system 1 installed in a garage to drive a door 2 between open and closed positions. A closure arm 4 connects the door 2 to a closure drive assembly. The closure drive assembly includes a motor operator 6. The motor of operator 6 is arranged to drive a longitudinal drive member in the form of a drive belt 8, arranged in a closed loop arrangement within or around a track 9, which extends between the door 2 and the operator 6. A drive device for the closure drive assembly in the form of trolley 3 moves along the track 9 and is connected to the closure arm 4. Mounted above the door 2 and received at the door end of track 9 is a belt tensioner 10. The belt tensioner 10 is configured to receive the belt 8 and allow a user to set and adjust the level of tension in the belt 8.

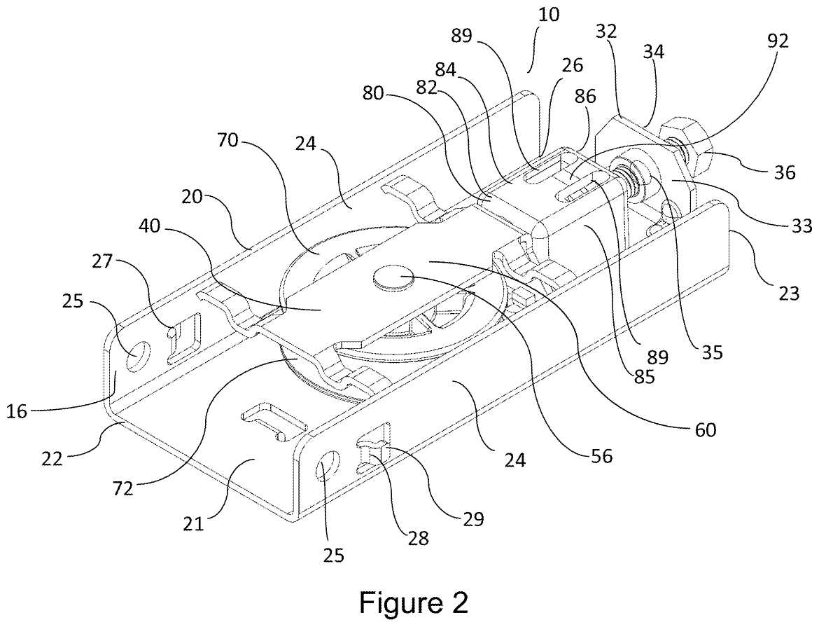

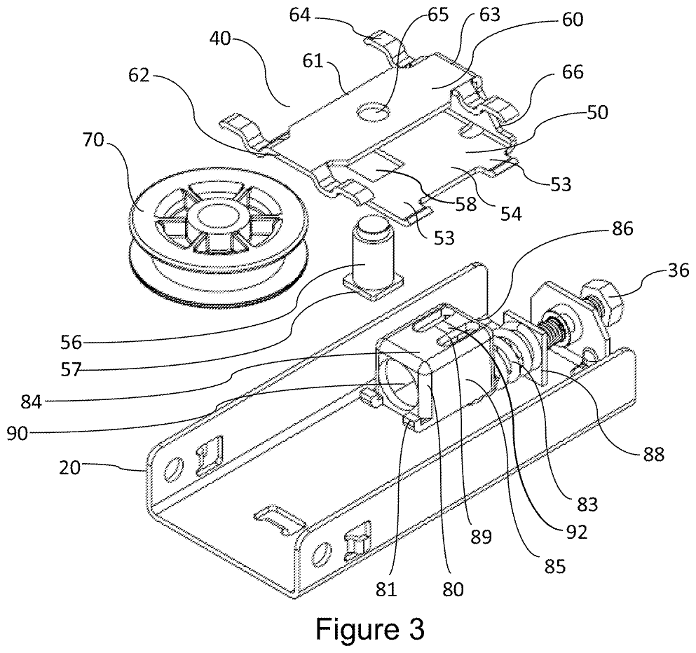

FIGS. 2 and 3 illustrate a belt tensioner 10 in accordance with an embodiment of the present invention. It will be appreciated that FIGS. 2 and 3 illustrate a view from a lower side of the belt tensioner 10 when in situ, i.e. mounted to a ceiling of a garage. Belt tensioner 10 includes a chassis 20 configured to be mounted to the track 9 at the door end thereof (see further below). The chassis 20 comprises a horizontal planar top web 21, having a front portion 22 and a rear portion 23. It will be understood that the front portion 22 faces the door 2, whilst the rear portion 23 faces the operator 6. A pair of lateral flange portions 24 extend downwardly and substantially perpendicular to the web 21, the chassis 20 thereby defining a substantially C-shaped channel with rounded flange corners as shown.

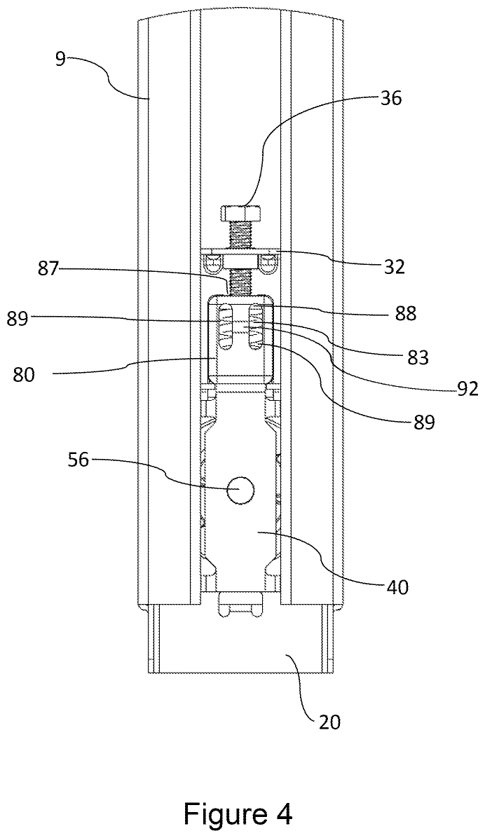

Chassis 20 is sized to fit within track 9 (as discussed further below with reference to FIG. 4), and may be formed in any conventional manner. For example, chassis 20 may be formed as an extruded section, formed by bending of an appropriate sheet material into the substantially C-shaped channel, or by welding the flange portions 24 to the top portion 21. An aperture 25 is provided in each lateral flange portion 24 towards the front portion 22 of the chassis 20. The apertures 25 are configured to receive fastening elements (not shown) that allow the chassis 20 to be mounted to a wall or other structure, generally above the door, by way of a suitable mounting bracket. The mounting of chassis 20 also provides support for the door end of track 9 as, once assembled, chassis 20 in effect forms a terminal extension of the track.

The rear portion 23 of chassis 20 includes an edge 26, from which downwardly and perpendicularly extends a shaped planar tab 32 as shown in FIGS. 2 and 3. The tab 32 has an inner surface 33 facing towards the front portion 22 of the chassis 20, and an outer surface 34 facing the operator 6. The tab 32 is formed by bending downwardly a protruding portion of horizontal planar top web 21, with reinforcing gussets pressed into the fold line as shown. Extending in a perpendicular direction and towards the front portion 22 from the inner surface 33 is an annular boss 35. Annular boss 35 is integral with or welded to tab 32 and has a threaded inner bore, which extends to outer surface 34 of the tab 32, thereby defining a passage for an adjustment bolt 36 to engage therein, as shown in FIGS. 2-4. Once the tensioner device is assembled in track 9, clockwise rotation of the hex head of adjustment bolt 36 advances the bolt in the direction of door 2. Adjustment bolt 36 is configured to engage other components of belt tensioner 10 as discussed below.

Chassis 20 further includes lateral hooked tabs 27 extending from the front portion 22 of each flange portion 24, inboard of apertures 25. The hooked tabs 27 have a first part 28 extending outwardly and perpendicular to an outer surface of each flange portion 24 and a second part 29 extending in a longitudinal direction towards the rear portion 23 from first part 28, as shown. Lateral hooked tabs 27 are configured to receive the leading edges of the lateral flanges of track 9 at a position that leaves clear apertures 25, hence ensuring the track does not interfere with the mounting of the chassis to the wall. The hooked tabs 27 are formed by stamping and folding from flange portions 24.

The belt tensioner 10 further comprises a carriage 40 to support idler pulley 70 for rotation; carriage 40 configured to move in the axial direction relative to chassis 20 when adjusting the level of tension in the belt, but constrained against movement in any other direction. Idler pulley 70 includes a profiled circumferential groove 72 that receives the belt (as is conventional in the art) and rotates by way of suitable bearings on a shaft 56, disposed vertically when in situ.

When viewed laterally, carriage 40 has a U-shaped form (see FIG. 3), comprising an upper carriage portion 50, a lower carriage portion 60 and an intermediate web providing force-receiving member 66, all three portions cut and folded from a single sheet of material. The open end of the U-shaped form allows idler pulley 70 to be inserted during assembly of the device between carriage portions 50 and 60.

Upper portion 50 is provided by a substantially planar body, comprising a pair of laterally extending shaped parts 53 and a bridging part 54 extending in the axial direction between parts 53. Thus, the upper portion is substantially ‘I’ shaped as best shown in FIG. 3. The upper portion 50 also includes a rectangular aperture 58 for receiving an upper rectangular end 57 of shaft 56 on which idler pulley 70 rotates. When in situ, the shaped lateral ends of parts 53 are in close proximity to the inner surface 16 of flange portions 24, affording smooth movement of the upper portion 50 in the axial direction, whilst preventing any substantial transverse movement.

The lower carriage portion 60 similarly includes an elongate body portion 61 having a front end 62 and a rear end 63. The body portion 61 is of substantially rectangular form extending to transversely extending opposed wings 64 that project laterally from the body portion 61 at each end. The wings 64 are each contoured in a substantially S-shape in order to complement the shaping of the inner channels of track 9. Like laterally extending parts 53 of upper portion 50, wings 64 facilitate the axial movement of the carriage 40 (and therefore idler pulley 70) relative to the track, precluding any lateral movement or yaw of carriage 40. Lower carriage portion 60 also includes an aperture 65 for receiving a lower end of shaft 56.

Connecting rear end 62 of body portion 61 with the rear end of upper carriage portion 50 is an intermediate web forming force-receiving member 66, the outer face of which faces the rear portion 23 of chassis 20 when assembled. As described further below, the force provided by the adjustment bolt 36 is ultimately transmitted to carriage 40 via force receiving member 66, thereby driving axial movement of the carriage 40 relative to the track 9 towards the front portion 22 of chassis 20.

Assembly of carriage 40 involves inserting bearing shaft 56 through idler pulley 70, and then inserting pulley 70 into carriage 40 to locate the ends of shaft 56 into the apertures of upper and lower carriage portions 50, 60. As FIG. 3 illustrates, shaft 56 is formed such that it projects no more than a minimum distance beyond the outer surfaces of the upper and lower portions 50, 60 of carriage 40, which might otherwise interfere with smooth lateral displacement of the device within chassis 20. In the assembled state, it is important that relative movement between the component parts of the carriage 40, the idler pulley 70 and shaft 56 is precluded, other than rotation of pulley 70 on vertical shaft 56.

Interposed between the adjustment bolt 36 and the carriage 40 is an intermediate assembly 80. Intermediate assembly 80 is configured to receive load provided by adjustment bolt 36 and transmit that load to carriage 40 to move the carriage 40 in the longitudinal direction towards the front portion 22 of chassis 20 when an increased level of tension in the belt is required.

The intermediate assembly 80 includes a hollow retainer housing 82 of generally cuboid form configured to retain a compression spring 83 in the space therein, as shown in FIGS. 2 and 4. The retainer housing 82, when viewed in situ (FIG. 2) is formed of a lower wall 84, a pair of side walls 85 extending upwardly and in a perpendicular direction from the lateral edges of lower wall 84, and a rear wall 86 that extends upwardly and in a perpendicular direction from the lower wall 84 from a rear edge thereof. The rear wall 86 includes an opening 87 (see FIG. 4) to provide passage for the threaded shank of adjustment bolt 36.

Opposite the rear wall 86 is an opening 90 provided by the substantial absence of a wall at the front side of the retainer housing 82 (see FIG. 3) that allows insertion of spring 83 into the retainer housing 82 on assembly of the device. Once the device is assembled, the spring 83 sits in contact with the force bearing surface of force bearing member 66. In an alternative embodiment, retainer housing 82 may include a front wall, with the spring 83 inserted in the retainer housing 82 through the opening opposite the lower wall 84 (provided by the substantial absence of a wall at the top side). Retainer housing 82 includes a pair of hooked lugs 81 (FIG. 3) which extend from side walls 85 and in an axial direction. These lugs are configured to engage with carriage 40, through a pair of corresponding apertures in carriage 40, thereby fixedly connecting the intermediate assembly 80 to carriage 40 for movement therewith.

The retainer housing 82 therefore provides a retention structure for spring 83, ensuring that the spring does not dislodge from its operational position during use. It will be readily appreciated that the spring may be retained in position in suitable ways other than by retainer housing 82. It will further be appreciated that intermediate assembly 80 need not be provided as a separate component, but may be part of or attached to carriage 40 or chassis 20 in a suitable manner. Operably connected with the spring 83 is a rectangular plate 88, which provides an adjustment bearing element. In the assembled belt tensioner 10, the end of the threaded shank of adjustment bolt 36 bears on one face of plate 88, while the end of spring 83 bears against the opposite face. When the adjustment bolt 36 is screwed inwardly (i.e. towards the front portion 22 of chassis 20), plate 88 acts to compress spring 83 which in turn transmits the load onto force receiving member 66. This urges carriage 40 towards the front portion 22 of chassis 20, thus increasing the tension in belt 8.

Intermediate assembly 80 thus acts as a shock absorber between adjustment bolt 36 and carriage 40, spring 83 absorbing any sudden jolts experienced by the belt when the door is moving between open and closed positions (particularly at starting and stopping of operator 6). In order for the spring to provide a sufficient level of shock absorption, the spring must be able to compress resiliently. Thus, during initial tensioning of the belt (or during further tensioning adjustments of the belt), it is important that the spring 83 is sufficiently preloaded, but not compressed beyond a threshold limit in order to allow it to provide the required shock absorbing function. For this purpose, the housing 82 provides a visual indication of the level of compression of the spring 83.

Reference is now made to FIG. 4, which illustrates the belt tensioner 10 received in the track 9. It will be appreciated that adjustment bolt 36 (and particularly the hex head of the bolt 36) is positioned within track 9 between the track rails provided by the surfaces of the inner channels thereof, accessible from the rear side (i.e. the operator-facing side), making it easier for a user to access and adjust the belt tension. Chassis 20 of belt tensioner 10 is received within track 9, with the wings 64 of the lower carriage portion 60 able to slide along the track rails, thereby allowing idler pulley carriage 40 to displace axially along the track.

Lower wall 84 of retainer housing 82 includes a viewing window, in the form of two axially extending elongate slots 89 that allows a user to view the level of compression of the spring 83 by observing the position of plate 88. As a general guide, slots 89 are disposed such that if plate 88 is visible then spring 83 is within a workable operating range, between a wholly uncompressed and a wholly compressed condition.

The ability to view the level of compression in the spring 83 assists a user when preloading the belt for a given door, or for readjusting the belt tension as part of a maintenance check. For example, the user may tension the tensioning device 10 to a prescribed preload in accordance with the size or type of door, by adjusting plate 88 to one of a number of positions along the length of slots 89. For a heavier door, the spring 83 may need to be compressed until element 88 is positioned in the front part of the viewing window 89, whilst for a lighter door the spring 83 may need to be compressed until the force receiving member 66 is positioned in a rear part of the viewing window 89. Visual indicators, such as incremental markers, may be provided on retainer housing 82 (such as the single marking 92 shown in FIGS. 2 to 4 between slots 89) to guide a user when setting or adjusting the tension.

Other suitable forms of visual indication of preload may be used. By way of example, retainer housing 82 may take the form of a cage (retaining spring 83 while allowing visual inspection of plate 88), or it may be wholly or partially transparent to allow visual observation. Alternatively, a pointer may protrude from retainer housing 82, the pointer in movable association with the spring (e.g. attached to plate 88). Observation of a viewable part of the pointer against graduations on an external part of housing 82 provide an indication of the level of compression of the spring. Alternatively an electronic means such as a sensor or other position indicating encoder may be used, to provide a visual indication to a user of spring compression (e.g. via a light, display, etc.).

Track 9 is described and illustrated as a C-shaped track which encloses drive belt 8 and trolley 3, however it will be understood that other forms of track may be used with the invention, such as an I-form rail, where trolley 3 is engaged around a part of the rail and the belt (or chain) runs alongside the rail. In such a version, idler pulley carriage 40 is arranged to displace along a front end portion of the I-form rail.

The chassis 20 and carriage 40 are formed of a material such as pressed steel. Pulley 70 is manufactured from a suitable engineering polymer, such as Dupont's Delrin®, an acetal homopolymer self-lubricating resin material, which is lightweight but durable, with suitable low wear and low friction properties, while the pulley axle shaft 56 is steel. Retainer housing 82 is made of a suitable lightweight polymer material such as Nylon. Spring 83 is fabricated from a tempered steel, although other suitable materials may be used.

It will be understood that the invention disclosed and defined in this specification extends to all alternative combinations of two or more of the individual features mentioned or evident from the text or drawings. All of these different combinations constitute various alternative aspects of the invention.

1. A tensioning device for a door operating system, the door operating system including a track, a longitudinal drive component to be tensioned, the longitudinal drive component running along the track between a track door end and a track operator end, a powered operator arranged to drive the longitudinal drive component and a pulley configured to operatively engage the longitudinal drive component adjacent the track door end, the tensioning device including:
a pulley carriage on which the pulley is mounted for rotation, the pulley carriage being movable relative to the track;
an adjuster configured to move the pulley carriage relative to the track and thereby alter a level of tension in the longitudinal drive component, the adjuster of the tensioning device being accessible from an end of the tensioning device facing said track operator end; and
a resilient member operatively engaged with the adjuster, the resilient member configured to provide damping of forces experienced by the longitudinal drive component.

2. The tensioning device of claim 1, wherein the adjuster includes a drive part for manipulation by a user to effect the adjustment, the drive part being disposed at a position on a side of the pulley carriage towards the track operator end.

3. The tensioning device of claim 2, wherein the drive part is a head of an adjustment bolt or screw, rotation of which effects adjustment of the level of tension in the longitudinal drive component.

4. The tensioning device of claim 1, wherein the adjuster is an adjustment bolt engaging with a threaded element mounted in a fixed position relative to the track, rotation of the adjustment bolt in a tightening direction bearing on the resilient member, which bears on the carriage.

5. The tensioning device of claim 4, wherein the adjustment bolt bears on a bearing element, which in turn bears on the resilient member.

6. The tensioning device of claim 1, further comprising a retention structure disposed between the carriage and the adjuster, the retention structure configured to confine the resilient member.

7. The tensioning device of claim 6, wherein the retention structure is configured to afford a visual indication of loading of the resilient member, thus providing to a user an indication of the level of tension in the longitudinal drive component.

8. The tensioning device of claim 7, wherein an adjustment bearing element is disposed within the retention structure, whereby visual inspection of a position of the adjustment bearing element within the retention structure provides an indication of the loading of the resilient member.

9. The tensioning device of claim 7, wherein the retention structure further includes one or more openings that allow a user to view the resilient member or a part operatively engaged with the resilient member.

10. The tensioning device of claim 7, wherein the tensioning device further includes an indicator element in operative engagement with the resilient member, the indicator element extending from the retention structure, with movement of the indicator element providing to a user a measure of the loading of the resilient member.

11. The tensioning device of claim 1, wherein the tensioning device further includes a chassis, wherein one or more component parts of the tensioning device are provided on the chassis, the chassis being configured to be mounted to the track.

12. The tensioning device of claim 1, wherein the resilient member is a spring.

13. The tensioning device of claim 12, wherein the resilient member is a compression spring.

14. The tensioning device of claim 1, wherein the pulley carriage further includes a surface on which load from the adjuster bears in order to move the carriage.

15. The tensioning device of claim 1, wherein the pulley carriage further includes lateral portions that engage with the track to facilitate axial movement of the pulley carriage along the track, while preclude substantial movement of the pulley carriage in any other direction.

16. The door operating system of claim 1, further including the tensioning device of claim 1.

17. The door operating system of claim 16, wherein the powered operator is a motor-powered operator configured to drive said longitudinal drive component.
